(19) United States
(12) Patent Application Publication
(10) Pub. No.: US 2009/0072999 A1
(43) Pub. Date: Mar. 19, 2009

(54) Navigation image display apparatus and method thereof

(76) Inventor: Ching Hsiang Yu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/000,583

(22) Filed: Dec. 14, 2007

(30) Foreign Application Priority Data
Sep. 17, 2007 (TW) 096134754

(51) Int. Cl. G08G 1/095

(52) U.S. Cl. 340/907

(57) ABSTRACT

This present invention provides a navigation image display apparatus and method thereof. The navigation image display apparatus comprises a Vacuum Fluorescent Display (VFD) module and a control module. The VFD module comprises at least one electric emitting part connected to a power source for generating a plurality of electrons; and a display part having a plurality of display areas which display images based on the electrons. The control module is operable to control the brightness of the display areas for displaying a navigation image. Preferably, the navigation image can comprise at least one image of turning left, straight ahead only, turning right, U turn left or U turn right, etc.

### FIELD OF THE INVENTION

This invention relates to a navigation image display apparatus and method thereof, and more particularly to a navigation image display apparatus and method of using Vacuum Fluorescent Display (VFD) module to display the navigation image having multi-directional arrows.

### BACKGROUND OF THE INVENTION

The navigation apparatus is getting popular at present, more and more drivers rely on the driving information provided from navigation apparatus, such as the map information, the destination route planning and the navigation information, etc. In order to prevent the driver from deviating his/her sight from the fore road while looking the navigation apparatus or further distracting to identify the navigation message so as to increases the risk factor of driving imperceptibly, many navigation apparatus are equipped with head-up display (HUD) to project the navigation message onto the windshield glass so that the driver can identify the navigation message without deviating his/her sight from the road.

Please referring to FIG. 1A for the schematic view of the navigation image display apparatus of the prior art, the conventional apparatus adopts 16×16 dot matrix means for displaying navigation messages. As illustrated, this conventional navigation image apparatus displays a navigation image of u-turn right. Such conventional navigation image display apparatus can be realized by using Liquid Crystal Display or Vacuum Fluorescent Display (VFD), however each yields insurmountable drawbacks.

If Liquid Crystal Display is adopted, this would lead to the light deficiency problem, especially while such navigation image display apparatus is applied to HUD, the driver is difficult to identify the navigation image displayed on the windshield glass, which is displayed by navigation image display apparatus in daytime.

Compared with Liquid Crystal Display, Vacuum Fluorescent Display has higher brightness and the driver is able to identify the navigation image on the windshield glass in daytime. However, adopting Vacuum Fluorescent Display to realize dot matrix means would result in the drawback of control circuit design difficulty caused by excess control points. As illustrated in FIG. 1A, the point matrix has 256 control points, thus the control circuit can be realized via wafer implant method, however the cost is high. If using the method of plug-in control circuit design, the circuit routing trace of the Vacuum Fluorescent Display is deployed on the glass substrate, and the space between traces must be larger than a constant space, hence the trace can not increase unconditionally due to the restriction of space limitation. Therefore, such a plug-in control circuit design method can not realize a large number of control points within a limited display area.

Besides, the dot matrix display means illustrated above also has the problem of having a serrate border at the edge of the image, such as the arc segment illustrated in FIG. 1A, furthermore, and the problem of not able to present more complex images due to the limited control points, as illustrated in FIG. 1B. The FIG. 1B shows a message of navigating user to drive right forward direction around the front traffic circle. It is very difficult for user to identify the image of the front traffic circle which is displayed on dot matrix having insufficient resolution.

In view of the drawbacks of the prior art, the inventor of the present invention based on years of experience in the related industry to develop a navigation image display apparatus and method thereof to overcome the drawbacks of the prior art.

### SUMMARY OF THE INVENTION

Therefore, it is one of objectives of the present invention to provide a navigation image display apparatus and method thereof for increasing the effectiveness of display as well as reducing the cost of the navigation image display apparatus.

According to the objective of present invention, this invention provides a navigation image display apparatus comprising a vacuum fluorescent display module and a control module. The vacuum fluorescent display module comprises a display part and at least one electric emitting part which is connected to a power source for generating a plurality of electrons. The display part has a plurality of display areas which display images based on the electrons. The control module is operable to control the brightness of the display areas for displaying a navigation image.

Preferably, the navigation image can comprises at least one image of turning left, straight ahead only, turning right, u turn left or u turn right, etc.

Preferably, the display areas can comprise a plurality of arrow display areas and a plurality of shaft display areas, and the navigation image is assembled in parts of the arrow display areas and the shaft display areas.

Preferably, the display areas are processed by means of photo etching.

Besides, the present invention further provides a navigation image display method comprising the steps of: providing a Vacuum Fluorescent Display module which comprises at least one electric emitting part connected to a power source for generating plurality electrons, and a display part for displaying images based on the electrons; forming a plurality of arrow display areas and a plurality of shaft display areas on the display part; controlling the brightness of the arrow display areas and the shaft display areas to assemble a navigation image in parts of the arrow display areas and the shaft display areas.

Preferably, the navigation image can comprise at least one image of turning left, straight ahead only, turning right, u turn left or u turn right, etc.

Preferably, the arrow display areas and said shaft display areas are processed by means of photo etching.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

The subject matter regarded as the invention is particularly pointed out and distinctly claimed in the concluding portion of the specification. The invention, both as to device and method of operation, together with features and advantages thereof may best be understood by reference to the following detailed description with the accompanying drawings in which:

FIG. 1A illustrates a schematic view of the navigation image display apparatus of prior art;

FIG. 1B illustrates a message of navigating user to drive right forward direction around the front traffic circle;

FIG. 2A illustrates a schematic view of the navigation image display apparatus with one embodiment in accordance with the present invention;

FIG. 2B illustrates a schematic view as shown in FIG. 2A of the turning right image displayed by display part;

FIG. 2C illustrates a schematic view as shown in FIG. 2A of the turning left image displayed by display part;

FIG. 3 illustrates a block diagram of the navigation image display apparatus with another embodiment of the present invention;

FIG. 4 illustrates a schematic view of the display part of the navigation image display apparatus;

FIG. 5 illustrates a flow diagram of the navigation image display method.

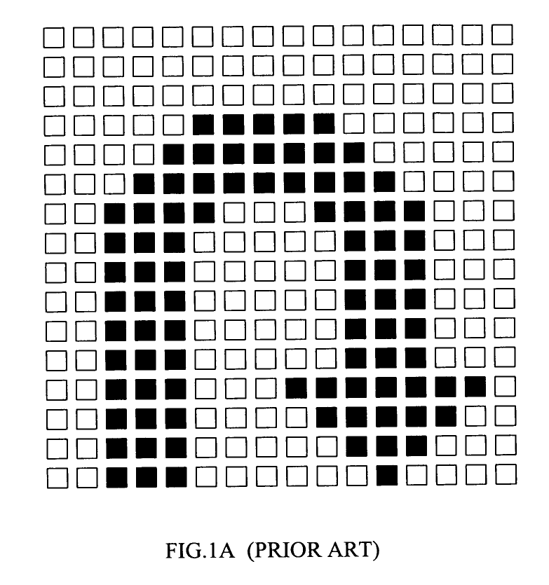

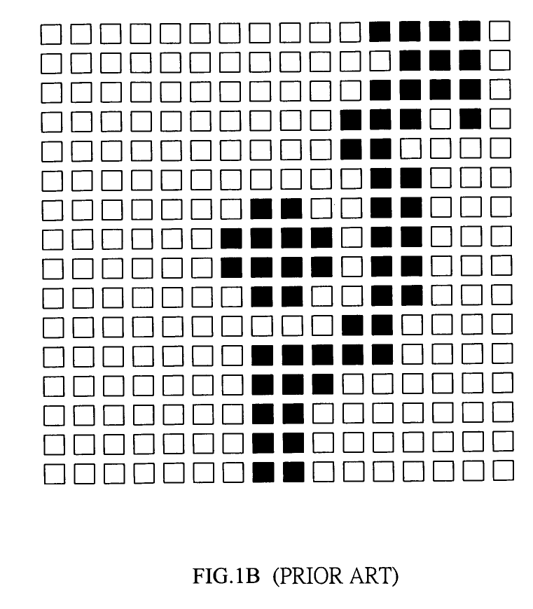

### DETAILED DESCRIPTION OF THE PREFERRED EMBODIMENT

The present invention relates to a portable navigation device. While the specifications describe at least one embodiment of the invention considered best modes of practicing the invention, it should be understood that the invention can be implemented in many ways and is not limited to the particular examples described below or to the particular manner in which any features of such examples are implemented.

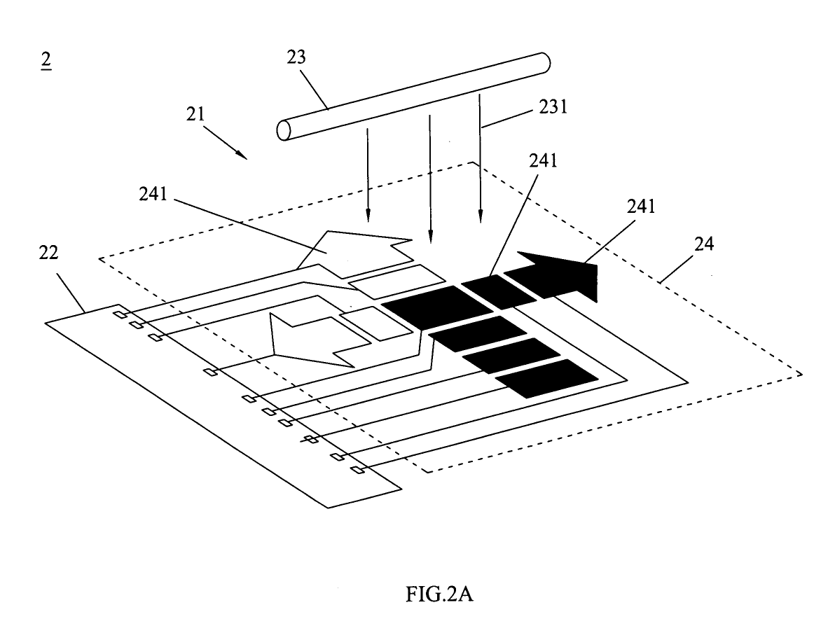

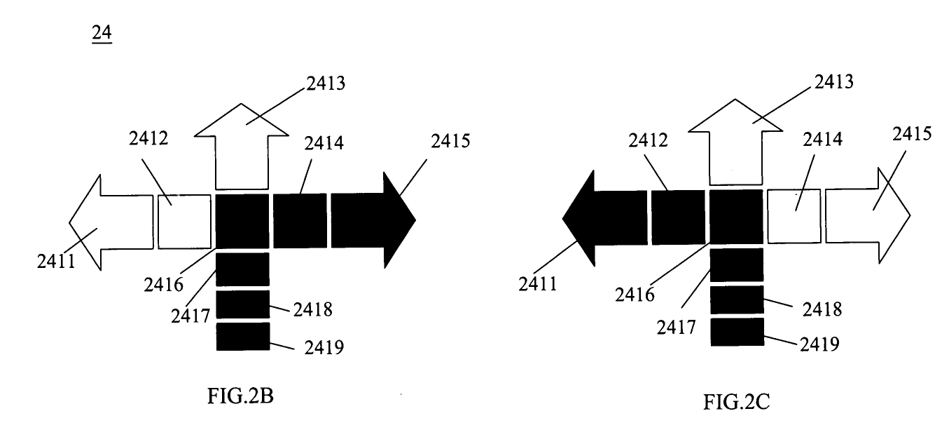

Please referring to FIG. 2A for a schematic view of the navigation image display apparatus with one embodiment in accordance with the present invention, the navigation image display apparatus 2 comprises a Vacuum Fluorescent Display (VFD) module 21 and a control module 22. The VFD module 21 comprises a display part 24 and at least one electric emitting part 23. The electric emitting part 23 is connected to a power source for generating a plurality of electrons 231, and the display part 24 has a plurality of display areas 241 which display image based on the electrons 231. The control module 22 connects to display areas 241 via various data lines correspondingly, in order to control the brightness of the display areas 241 via these data line for displaying a navigation image. Preferably, the control module 22 can be a control IC, a micro processor or a control logic circuit.

Preferably, the electric emitting part 23 can comprise a filament or a tungsten filament, the display area 241 preferably comprises a positive electrode, and the positive electrode can be covered with fluorescent layer if necessary. When a certain display area needs be lighted off, the control module 22 applies the negative voltage to positive electrode of said display areas through a corresponding data line, on the contrary, for a certain display area needs be lighted on, the control module 22 applies the positive voltage to negative electrode of said display area through corresponding data line to attract electrons to impact the fluorescent layer for fluoresce.

Preferably, the navigation image can comprise at least one image of turning left, straight ahead only, turning right, u turn left or u turn rig, etc. Additionally, the display area 241 preferably comprises a plurality of arrow display areas and a plurality of shaft display areas, and the navigation image is assembled in parts of the arrow display areas and the shaft display areas.

FIGS. 2B and 2C illustrate the schematic views of a left turning image and a right turning image displayed by display part 24 illustrated in diagram 2A respectively. Simply for the purpose of easier to explain, the nine display areas 241 are labeled with numerical notation 2411-2419 respectively. The display areas of 2411, 2413 and 2415 are arrow display areas, and the display areas of 2412, 2414, 2416, 2417, 2418 and 2419 are shaft display areas. As illustrated in FIG. 2B, while control module 22 applies a positive voltage to negative electrodes of 2414, 2415, 2416, 2417, 2418 and 2419 through the corresponding data lines, and applies negative voltage to positive electrodes of the rest display areas, so as the display part is displaying a right turning image. As illustrated in FIG. 2C, while control module 22 applies a positive voltage to positive electrodes of 2411, 2412, 2416, 2417, 2418 and 2419 through the corresponding data lines, and applies negative voltage to positive electrodes of the rest display areas, so as the display part is displaying a left turning image.

It is noted that there is only one electric emitting part 23 illustrated in FIG. 2A, however, VFD module 21 can comprise, if necessary, a plurality of the electric emitting parts 23 for providing adequate electron sources, and the positions of these electric emitting parts 23 can be preferably mapped to the corresponding display area 241. Besides, in order to realize diversified and more complex navigation images, the navigation image display apparatus 2 can comprise, if necessary, a storage unit for storing a correspondence data between plural display areas 241 and plural navigation images. The control module 22 controls the display area 241 to display the complex navigation images based on the correspondence data. The storage unit may alternatively be provided as for example, RAM, ROM or flash memory. Preferably, the display areas illustrated above can be processed by means of photo etching for yielding display areas having smooth border. Then, the disadvantage of non-identifiable navigation image caused by the saw tooth border can be resolved.

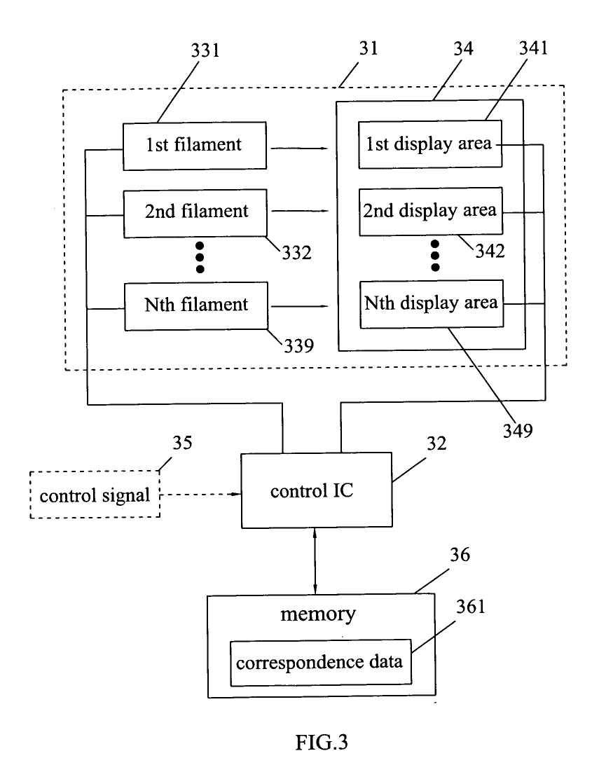

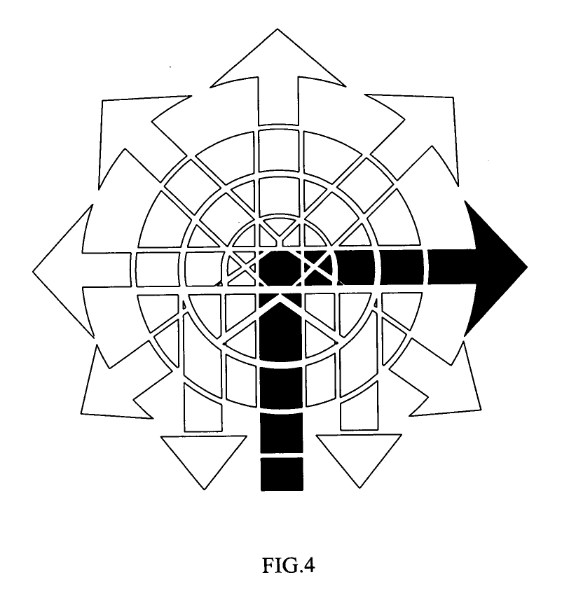

Please referring to FIG. 3 for a block diagram of the navigation image display apparatus with another embodiment in accordance with the present invention, the navigation image display apparatus 3 comprises a VFD module 31, a control IC 32 and a memory part 36. The VFD module 31 comprises a plurality of filaments of 331-339 and a display part 34. The filaments 331-339 are connected to a power source for generating electrons. The display part 34 has a plurality of the display areas 341-349 which display the image based on the electrons. Particularly, the locations of these filaments are corresponding to these display areas. The control IC 32 is coupled to the filaments 331-339 and display areas 341-349, this is for controlling the brightness of the display areas 341-349 to display a navigation image. When only the first display area 341 and the second display area 342 are desired to light on, the control IC 32 would electrify the first filament 331 and the second filament 332 to generate electrons and leave the rest filaments intact. Herewith the power consumption of the navigation image display apparatus 3 can be reduced.

The memory 33 is for storing the correspondence data 361 between a plurality of navigation images and display areas 341-349. When receiving a control signal 35, the control IC 32 can obtain the display areas are targeted to light based on the correspondence data 361, and then control the targeted display areas to display a navigation image corresponding to the control signal 35.

FIG. 4 illustrates a schematic view of the display part of the navigation image display apparatus with another embodiment in accordance with the present invention. Compared with FIG. 2A, the display areas illustrated in FIG. 4A are more complex and capable of displaying more navigation images. The display area 41 is the arrow display areas, and the other areas are shaft display areas. It is noted that this preferred embodiment is for example, nut not limited, whichever related technique of using VFD module for lighting and using assembling means to display diversified navigation images, such as turning left image, turning left oblique image, U turn left image, straight ahead only image, turning right image, turning right oblique image, U turn right image, traffic circle image, double traffic circle image, a forked road or multi-forked road image, etc., herein are encompassed within the scope of the present invention.

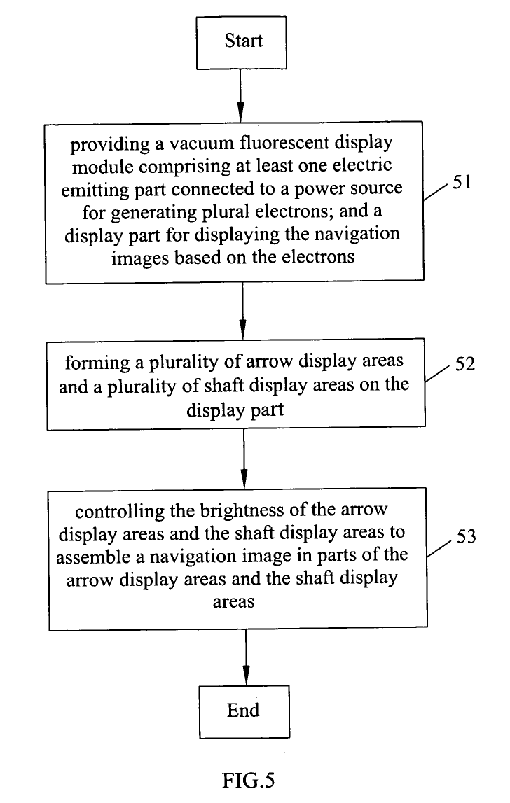

Please referring to FIG. 5 for a flow chart diagram of the navigation image display method with one embodiment in accordance with the present invention, the method deploys from the start and includes the steps of:

step 51: providing a vacuum fluorescent display module which comprises a display part and at least one electric emitting part, wherein the electric emitting part is connected to a power source for generating plural electrons, and the display part is operable to display the navigation images based on the electrons;

step 52: forming a plurality of arrow display areas and a plurality of shaft display areas on the display part, wherein the display areas are preferably processed by means of photo etching;

step 53: controlling the brightness of the arrow display areas and the shaft display areas to assemble a navigation image in parts of the arrow display areas and the shaft display areas; and lastly, terminating this process.

Before step 53 is executed, the method can comprise a step of providing a correspondence data between a navigation image, the arrow display areas and the shaft display areas, and then controlling the brightness of the arrow display areas and the shaft display areas based on said correspondence data.

While the invention has been described in a way of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A navigation image display apparatus, comprising:
a Vacuum Fluorescent Display (VFD) module, comprising at least one electric emitting part and a display part, wherein said electric emitting part is connected to a power source for generating plural electrons, and said display part has a plurality of display areas which display image based on said electrons; and
a control module, for controlling the brightness of said display areas to display a navigation image.

2. The navigation image display apparatus of claim 1, wherein said navigation image comprises at least one image of turning left, straight ahead only, turning right, u turn left or u turn right.

3. The navigation image display apparatus of claim 1, further comprising a storage unit, for storing a correspondence data between said display areas and said navigation image, wherein said control module controls the brightness of said display areas to display said navigation image based on said correspondence data.

4. The navigation image display apparatus of claim 1, wherein said display areas comprise a plurality of arrow display areas and a plurality of shaft display areas, and said navigation image is assembled in parts of said arrow display areas and said shaft display areas.

5. The navigation image display apparatus of claim 1, wherein said electric emitting part comprises a filament or a tungsten filament.

6. The navigation image display apparatus of claim 1, wherein said display area comprises a positive electrode.

7. The navigation image display apparatus of claim 6, wherein said positive electrode is covered with a fluorescent layer.

8. The navigation image display apparatus of claim 1, wherein said display areas are processed by means of photo etching.

9. The navigation image display apparatus of claim 1, wherein said VFD module comprises a plurality of electric emitting parts, and the location of said electric emitting parts are corresponding to said display areas respectively.

10. The navigation image display apparatus of claim 1, wherein said navigation image display apparatus is applied to a Head-Up Display (HUD).

11. A navigation image display method, comprising the steps of:
providing a Vacuum Fluorescent Display (VFD) module which comprises at least one electric emitting part connected to a power source for generating plural electrons, and a display part for displaying images based on said electrons;
forming a plurality of arrow display areas and a plurality of shaft display areas on said display part; and
controlling the brightness of said arrow display areas and said shaft display areas to assemble a navigation image in parts of said arrow display areas and said shaft display areas.

12. The navigation image display method of claim 11, wherein said navigation image comprises at least one image of turning left, straight ahead only, turning right, U turn left or U turn right.

13. The navigation image display method of claim 11, further, comprising a step of providing a correspondence data between said navigation image and said display areas.

14. The navigation image display method of claim 11, wherein said electric emitting part comprises a filament or a tungsten filament.

15. The navigation image display method of claim 11, wherein said arrow display areas and said shaft display areas are processed by means of photo etching.

16. The navigation image display method of claim 11, wherein said VFD module comprises a plurality of electric emitting parts, and the location of said electric emitting parts are corresponding to part of said arrow display areas and part of said shaft display areas respectively.
